(19) United States
(12) Patent Application Publication
(10) Pub. No.: US 2019/0025148 A1
(43) Pub. Date: Jan. 24, 2019

(54) Water Leak Detection Based on Pipe Heating/Cooling Rate

(71) Applicant: CLO HOLDINGS, LLC, Great Neck, NY (US)

(72) Inventor: Elkana Tombak, Lakewood, NJ (US)

(21) Appl. No.: 15/656,205

(22) Filed: Jul. 21, 2017

(51) Int. Cl. G01M 3/00

(52) U.S. Cl. CPC G01M 3/002

(57) ABSTRACT

Comparing rate of temperature change of ambient air versus a pipe is used to find a pipe leak. By measuring the rate of change, rather than simply measuring temperature, and determining an expected rate for flow of water compared to an actual rate, one can more accurately determine the presence or absence of a leak, regardless of whether the diurnal temperature variation is large or small. A leak detection device of embodiments of the disclosed technology has two temperature sensors. A first measures temperature of a pipe, such as by having a probe or the body of the thermometer itself in contact with an exterior of the pipe. A second temperature sensor measures ambient room temperature. This second temperature sensor can be integrated into a housing with the first sensor and other electronics, or can be set up in another place in the room.

### FIELD OF THE DISCLOSED TECHNOLOGY

The disclosed technology relates generally to finding water leaks and, more specifically, to methods and a device for finding leaks based on a rate of heating/cooling/temperature change of a pipe.

### BACKGROUND

A problem of water waste from leaking pipes exists, especially in apartment buildings, office buildings, and places with many floors, where it is often difficult to find the source of the leak. A way of accurately finding the location of leaks, so they can be repaired, is needed. In the prior art, there are those who have used temperature measurements to detect pipe leakage, but each has inherent drawbacks. Temperature change of a pipe does not necessarily indicate water leakage. This is a problem found by the inventors when using prior art systems, which resulted in development of a new, more accurate, system which will be discussed in the summary below.

For example, in a desert climate such as Flagstaff, Ariz., the diurnal temperature variation (24 hour period of temperature change) regularly varies 15 to 20 degrees Celsius. Detecting a 10 degree change in temperature of a pipe might not actually indicate a leak at all for water flowing from a colder or warmer place, yet another variation which can affect accuracy of detecting a leak based on temperature. On the other hand, a place like Washington, D.C. might have an average diurnal temperature variation of only 8 degrees Celsius, and New York City, 4 degrees. Without taking into account these temperature changes, one will be left with false positives or false negatives for pipe temperature change in many situations.

PCT Patent Publication WO 2015/028629 discloses detecting water leak of a pipe using thermostats. A temperature sensor is placed on a pipe, and threshold high and low temperature values are determined. An alarm is activated when the low temperature is found. More specifically, on page 5 the inventor writes, “If at night the temperature of the water pipe is within the lowest temperature with the threshold added, then this is indicative of a leak being present.” Thus, while this reference discloses the concept of attaching a thermometer to a pipe, measuring its temperature, and determining that the temperature is lower than expected, it can produce false positives and false negatives, based on relying on temperature change without accounting for other factors that can result in temperature change of water.

U.S. Pat. No. 5,343,737 to Baumoel discloses leak detection at a point on a pipe using temperature, as well as measuring ambient temperature. Different sections of pipe are measured by temperature, and a volume change is determined if the volume change is too much per temperature. It appears that the invention is directed towards determining volume change, and temperature measurements are ancillary to this, as a change in temperature also changes volume.

U.S. Patent Publication 2014/0306828 to Trescott et al. discloses a flow meter in a pipe which determines that there is a leak, based on the movement of water within a pipe when none is expected. No reference has specifically been found to the concept of measuring temperature, however.

What is needed is a way to more accurately determine leaks in pipes by way of non-invasive mechanisms.

### SUMMARY OF THE DISCLOSED TECHNOLOGY

The present technology solves the problems of the prior art by comparing rate of temperature change of ambient air versus a pipe, rather than simply measuring the temperature of the pipe. The rate of heat loss of a body is proportional to the difference in temperatures between the body and its surroundings (Newton's Law of Cooling). By measuring the rate of change, rather than simply measuring temperature, and determining an expected rate for flow of water compared to an actual rate, one can more accurately determine the presence or absence of a leak, regardless of whether the diurnal temperature variation is large or small.

A leak detection device of embodiments of the disclosed technology has two temperature sensors (e.g., thermometers or other devices which measure temperature). A first measures temperature of a pipe, such as by having a probe or the body of the thermometer itself in contact with an exterior of the pipe. A second temperature sensor measures ambient room temperature. This second temperature sensor can be integrated into a housing with the first sensor and other electronics, or can be in another place in the room. “Room” is defined, for purposes of the disclosure, as an open space mostly or fully enclosed by walls. A timing device measures time passed.

A hardware storage device stores temperature of the pipe as measured over time, as well as ambient room temperature measured over time. The hardware storage device can include volatile or non-volatile memory. A packet-switched transmitter, such as a Wi-Fi transmitter (e.g., 802.11, cellular, TCP/IP, or other known protocols used in wired and/or wireless packet-switched data transmission) is used, in embodiments of the disclosed technology, to transmit the temperature data to another, such as a central, location. The central location can be at a device with the hardware storage or another hardware storage device, a processor carrying out instructions, a display, and the like. The central location can also receive temperature output from numerous leak detection devices and/or temperature sensors, such that there is at least one temperature sensor per pipe being reported to the central location.

Based on output of the timing device and the storing of the temperature information, a rate of change in temperature of a pipe is determined over a period of time. Further, a rate of change of the ambient temperature is determined over a period of time. Upon detection of a rate of change of temperature of the pipe being less than a threshold compared to a rate of change of the ambient room temperature, an alarm is triggered. An “alarm” can be a written, displayed, or sound notification of a leaking pipe, a person or automated process indicating to another or storing data indicative of a leaking pipe, or an interpretation of the data made which is used to check a pipe for leaks.

The timing device, at least one hardware storage device, and the packet-switched transmitter are within a housing, in embodiments of the disclosed technology. This housing is fixed to an exterior side of a/the pipe, and the first temperature sensor is in contact with an exterior side of the pipe, in such an embodiment. The second temperature sensor is on a side of the housing opposite the first temperature sensor in some such embodiments. In others, the second temperature sensor is anywhere in the room, measuring ambient room temperature. The second temperature sensor can also be used in conjunction with a plurality of leak detection devices simultaneously.

The rate of change of temperature of the pipe is/can be either a rate of cooling (hot water pipe leaking or very cold room) or heating (cold water pipe leaking or very hot room), and the temperature of the pipe is compared to the ambient room temperature over a period of time to further determine whether to trigger the alarm. In some embodiments, an alarm is triggered only when said change in temperature reported by said first temperature measuring device persists over a minimum threshold period of time.

A lack of change in temperature of a pipe over the minimum threshold period of time signals a lack of alarm in some embodiments, when the temperature of the pipe equals the ambient room temperature. In contrast, a lack of change of a period of time does signal an alarm, when the pipe is remaining a temperature far away from the ambient temperature, such as at least 10 degrees Celsius different from the ambient room temperature.

One can use devices described herein-above by measuring the temperature of a pipe with the first temperature sensor, while simultaneously (defined as “within 5, 30, or 60 seconds” or “periodically over at least three hours”), or non-simultaneously (while extrapolated or comparing temperature graphs of the course of time measured) measuring ambient room temperature with a second temperature sensor. Output of the first and the second temperature sensor is stored in a hardware storage device. This output is transmitted via a packet-switched network/transmitter, and a determination is made as to the rate of change of the pipe temperature, compared to the ambient temperature. If the rate of change is too slow, such as during a period of low (less than 70% of the average daily usage) or no usage than it should be, according to Newton's Law of Cooling, for the mass and density of the water, pipe, and ambient air, then it can be determined that the pipe is leaking. The output of the measurements (the “results” of the data) can be transmitted wirelessly via a packet-switched or circuit-switched network, transmitting results of said measuring wirelessly. Then, the step of determining that the rate of change of the temperature is too slow, is carried out based on data received wirelessly in some embodiments.

### BRIEF DESCRIPTION OF THE DRAWINGS

FIG. 1 shows a high level representation of elements of a measuring device used in embodiments of the disclosed technology.

FIG. 2 shows a high level representation of multiple pipes with measuring devices used in embodiments of the disclosed technology.

FIG. 3 is a flow chart showing a method of carrying out embodiments of the disclosed technology.

FIG. 4 shows a graph of temperature measured for two pipes over a period of time, in embodiments of the disclosed technology.

FIG. 5 shows a graph of ambient temperature measured in a room with the measurement devices, in embodiments of the disclosed technology.

FIG. 6 is a high level block diagram of devices used to carry out embodiments of the disclosed technology.

### DETAILED DESCRIPTION OF EMBODIMENTS OF THE DISCLOSED TECHNOLOGY

A device with a temperature sensor on either side is part of the disclosed technology. A first temperature sensor measures temperature of a pipe on which the device is situated (in contact with via the body of the device or a temperature probe), removably (placed on and off multiple times without causing damage to the device or pipe), or fixedly (causing irreversible damage to at least a part of the device, if removed) attached. The device can be battery powered or wired to an external power source. The device can have network connectivity (send data via a packet-switched or circuit-switched network) via a wireless or wired network connection.

The temperature sensors are spaced apart, in embodiments of the disclosed technology, such as an opposite side of the device or near opposite sides (within 10% of opposite extreme ends of the device and/or a temperature problem past the end of opposite extreme end of the device). One thermometer measures ambient room or air temperature, while the other device measures external pipe temperature (temperature of the pipe itself, such as on the exterior thereof). The thermometer measuring ambient temperature can be a separate thermometer, unattached to the pipe, in some embodiments, while in others, it is on the device which is attached to the pipe. Multiple such devices can communicate via a wireless and/or wired network to report ambient temperature and/or temperature of a pipe. Thus, at a centralized location, temperatures of multiple pipes can be reported.

Thus, the external temperature of one or a plurality of pipes is/are measured. When water flows through the pipes, the temperature generally drops (in some embodiments, the temperature rises). That is, water from an external water source outside of the building where the temperature is being measured (e.g., from a city water supply or well) might be about 60 degrees Fahrenheit, while the room temperature and/or ambient air temperature is 73 degrees. (All temperatures given are in Fahrenheit unless otherwise specified, due to the greater gradations of the Fahrenheit scale compared to the Celsius scale and larger numerical differences between temperatures discussed.)

Newton's law of cooling states that the rate of heat loss of a body is proportional to the difference in temperatures between the body and its surroundings. As such, it is equivalent to a statement that the heat transfer coefficient, which mediates between heat losses and temperature differences, is a constant. Thus, a pipe with flowing water received from the exterior to the building which is cooler than the ambient temperature of the building, will be about equal to the temperature of the flowing water. As the water stops flowing, the pipe (and water inside) approaches the ambient temperature either by way of the water in the pipe warming to this temperature, or in other embodiments, such as when using a hot water pipe, cooling to this temperature.

Embodiments of the disclosed technology will become clearer in view of the following description of the figures.

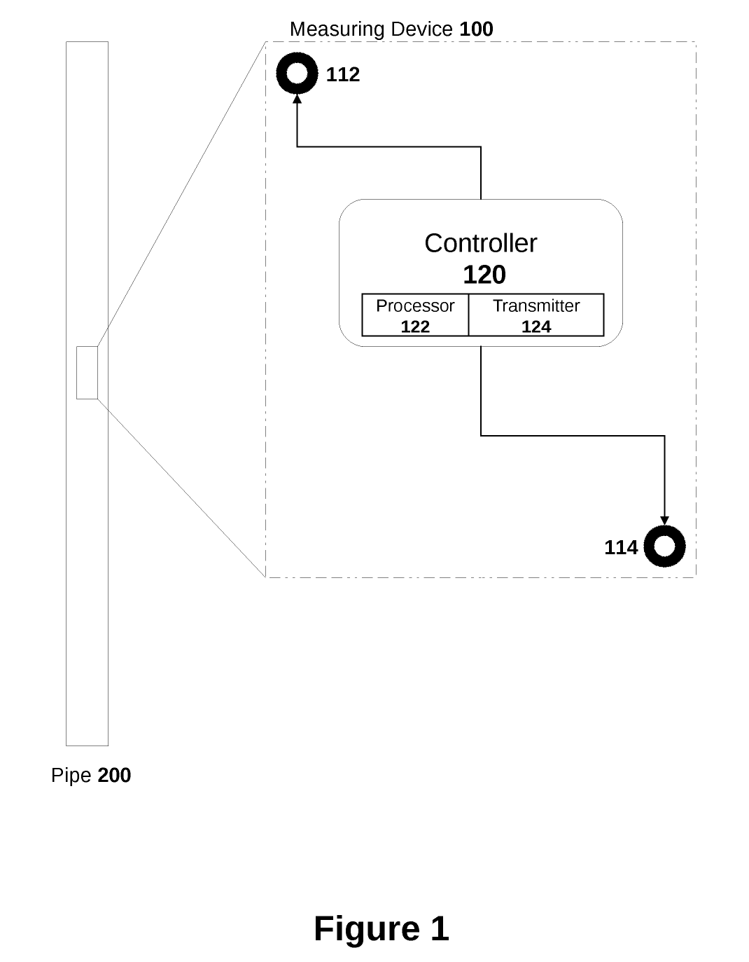

FIG. 1 shows a high level representation of elements of a measuring device used in embodiments of the disclosed technology. A pipe 200 carries water from outside a building through the building to other pipes or end users of water. A measuring device 100 is placed on the outside of the pipe and held there-to by tieing, sticking, gravitational force, or otherwise. In some embodiments, only a temperature probe 112 is placed on the pipe. The measuring device has two such temperature probes 112 and 114 either internal or external to a housing of the measuring device 100. A controller receives input from the temperature probes (or, in some embodiments, from a single temperature probe connected to the device). The second temperature probe 114 can be on, in, or electrically coupled to, the controller 120 or can be separate, measuring ambient temperature of a room or air having about the same temperature as within 2 meters of the pipe. A processor 112 receives and carries out instructions, and a transmitter 124 transmits the temperature information to another device, such as a central station. As such, many such measuring devices 100 can be used, the output of which can be compared to locate leaking pipes based on temperature fluctuations, or lack thereof, measured by each such device.

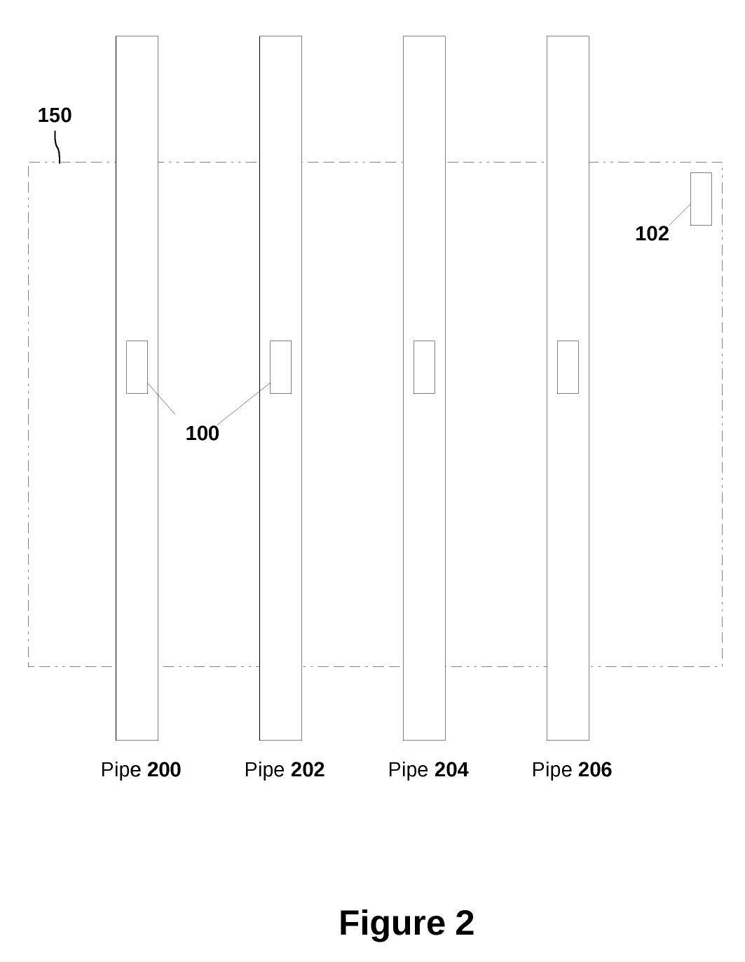

FIG. 2 shows a high level representation of multiple pipes with measuring devices, used in embodiments of the disclosed technology. Here, multiple pipes 200, 202, 204, and 206 pass through/into a room 150. Each pipe used in embodiments of the technology is affixed with, or has abutted there-to, a temperature measuring device 100. The room has an ambient air temperature measured by a temperature measuring device 102, or by a thermometer, on one or more of the temperature measuring devices 100 which is/are on a pipe. The temperature measuring device 102, which measures ambient room temperature, can be, in embodiments, anywhere within the room. In this manner, ambient air temperature and temperature of one or a plurality of pipes in a room can be compared to see if the rate of change in temperature of a pipe is too slow compared to the rate of change of temperature of the room.

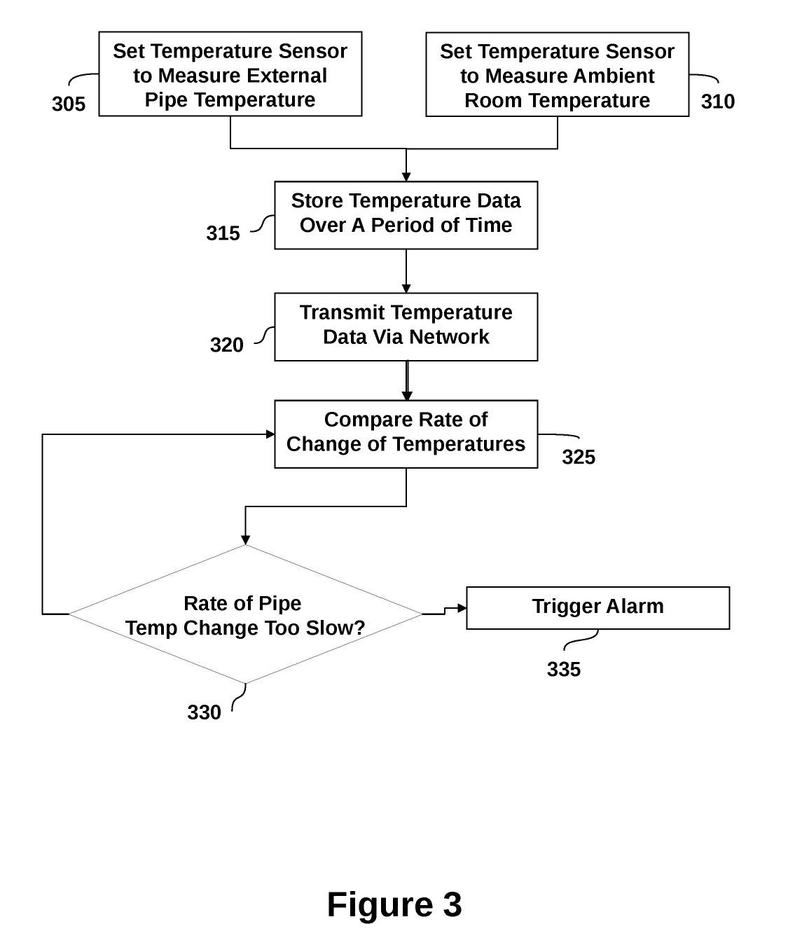

FIG. 3 is a flow chart showing a method of carrying out embodiments of the disclosed technology. In step 305 one sets a temperature sensor to measure external pipe temperature, such as by using the temperature measuring device 100 or the like, and abutting same to an exterior side of a pipe. Another temperature sensor (e.g., on device 100 or 102) measures ambient air temperature in the room. These temperature data, from both sensors, are stored over a period of time in step 315, such as over 24 hours, one week, or four weeks. The temperature data are transmitted via a packet-switched network in step 320 (which can take place in any order, such as before, or before and after step 315). In step 325, the rate of change of temperature (Δt) is determined by, such as, determining a formula for a line equation which best plots the temperature of a pipe (as measured in step 305) over time, and taking the derivative thereof.

This rate of change during low usage times which follow high usage times should be highest, and this should be seen fairly consistently over a period of days. However, this is further modified by the rate of change of the ambient temperature which is outside of the control of the system described herein. Ambient temperature can be a function of heating, cooling, or lack thereof in the room and/or the outside air temperature. Thus, one can use Newton's law of cooling and adjust what is the expected rate of change for a particular time period based on the ambient room temperature and its rate of change on different days. One skilled in the art of integrals and derivatives will appreciate that, by using inputs of previous time period rates of change and a difference in ambient temperature and ambient temperature rate of change, one can approximate an expected pipe temperature at any given time in the future. This expected pipe temperature, when different from actual measured pipe temperature over a period of time (such as over one hour and/or one hour after a highest rate of change of temperature in a pipe being measured) is out of bounds, then an alarm can be triggered in step 335. This follows the afore-described determination in step 330 that a rate of temperature change is too slow. This rate of change in pipe temperature can be a change to a higher temperature (e.g., when the room temperature is higher than water temperature in a flowing pipe) or change to a lower temperature (e.g., when the room temperature is lower than water temperature in a flowing pipe).

FIG. 5 shows a graph of ambient temperature measured in a room with the measurement devices, in embodiments of the disclosed technology. This is a typical graph of time (x-axis) vs. temperature (y-axis). This might be a 24-hour graph, where the temperature indicated by line 505 in graph 500 is at its lowest at night and highest at mid-day.

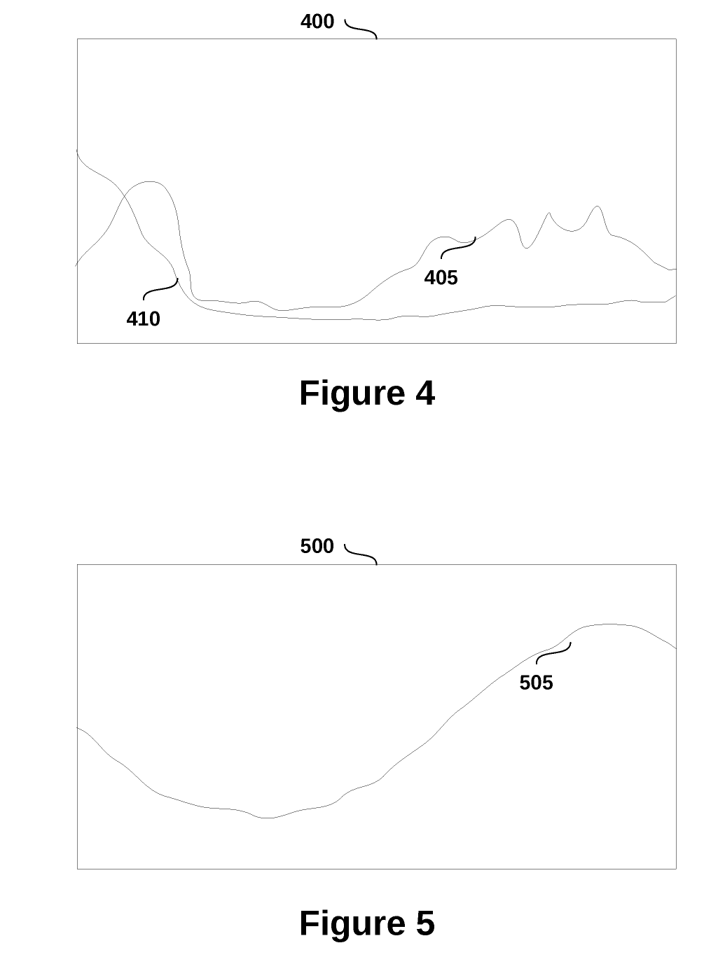

FIG. 4 shows a graph of temperature measured for two pipes over a period of time, in embodiments of the disclosed technology. At a first building, in this case referred to as “97 Brooklyn Ave,” a test site for the product, one can see that over a 24-hour period the pipe temperature 410 stays fairly constant. The temperature hovered between about 64 degrees and 66 degrees in one graph, and between about 66 and 69 degrees in another (not shown). This is due to the water temperature from a water carrier (water supplier external to the building) being about 64 and 66 degrees, respectively. Thus, when the water is constantly running, there a is constant new input of water through the pipe at about the temperature at which it enters the building.

Compare this to graph line 405. Here, note that over a 24-hour time period (x-axis) the temperature (y-axis) moves from a low of about 65 degrees to a high of 84 degrees. There are, additionally, much wider swings of temperature. This is due to the fact that, at certain hours of the day, there are much higher usages of the water than during other hours. The high peak near the left of the graph reflects the early morning hours (e.g., from about 2 am to 6 am), when there is little to no water usage in the building and/or downstream from the pipe, with the device attached measuring its temperature. As such, the temperature of the water in the pipe rises, as does the temperature of the pipe, to about 84 degrees. This is because the temperature in the room (defined as an open space mostly enclosed by walls) is also 84 degrees. For purposes of this disclosure, “about” is within 1 degree. Thus, the temperature of the pipe at first quickly rises, and then more slowly rises, until reaching the ambient temperature of the room.

One can look at the slope of the rise in temperature and difference from pipe temperature (measured by a first thermometer on the device attached to the pipe) and the ambient room temperature (measured by a second thermometer on the device) to determine water usage and/or pipe leakage. When there is a fairly constant temperature (e.g., most of line 410), and/or the temperature rise is less (on an order of magnitude of 20% and/or 5 degrees) than compared to other pipes over a period of 4, 8, 12, 18, or 24 hours, as measured by other measuring devices in the same room (e.g., one device per pipe), then a leak can be considered to be detected. One can then look at piping or pipes, which are connected downstream from the pipe, with the device measuring temperature to find the leak. If a leak still can't be found, then such a temperature-measuring device can be placed on downstream pipes or piping and the process repeated.

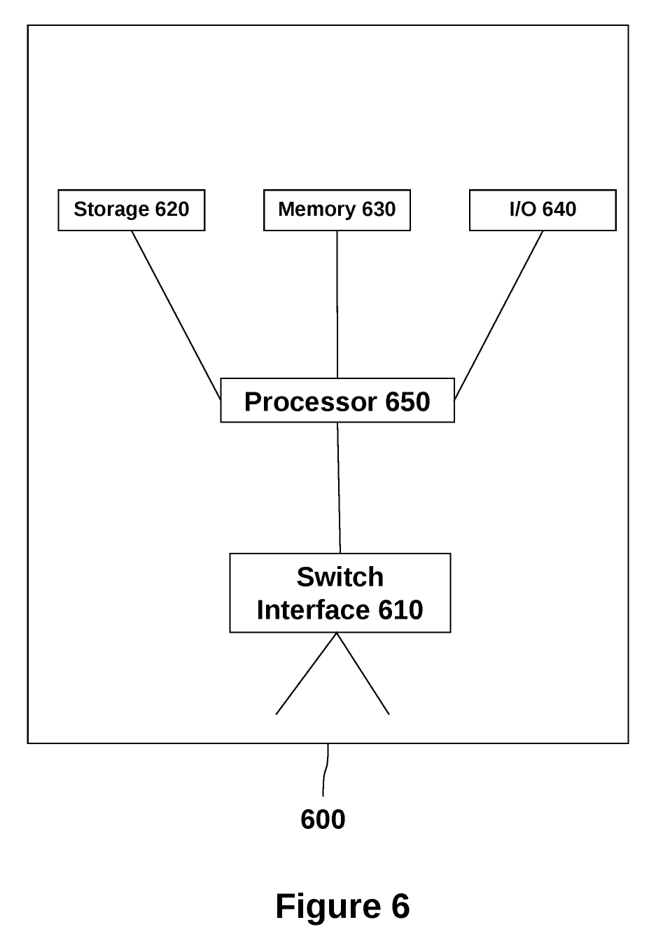

FIG. 6 is a high level block diagram of devices used to carry out embodiments of the disclosed technology. FIG. 4 shows a high-level block diagram of a device that may be used to carry out the disclosed technology. Device 600 comprises a processor 650 that controls the overall operation of the computer by executing the device's program instructions which define such operation. The device's program instructions may be stored in a storage device 620 (e.g., magnetic disk, database) and loaded into memory 630 when execution of the console's program instructions is desired. Thus, the device's operation will be defined by the device's program instructions stored in memory 630 and/or storage 620, and the console will be controlled by processor 650 executing the console's program instructions. A device 600 also includes one, or a plurality of, input network interfaces for communicating with other devices via a network (e.g., the internet). The device 600 further includes an electrical input interface. A device 600 also includes one or more output network interfaces 610 for communicating with other devices. Device 600 also includes input/output 640 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device, for illustrative purposes. It should also be understood by one skilled in the art that the method and devices depicted in FIGS. 1 through 5 may be implemented on a device such as is shown in FIG. 6.

Further, it should be understood that all subject matter disclosed herein is directed to, and should be read only on, statutory, non-abstract subject matter. All terminology should be read to include only the portions of the definitions which may be claimed. By way of example, “computer readable storage medium” is understood to be defined as only non-transitory storage media.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

1. A leak detection device, comprising:
a housing affixable to the exterior of a pipe;
a first temperature sensor positioned within said housing and being within contact or near said pipe for measuring and reporting pipe temperature;
a second temperature sensor positioned within said housing and being opposed to said first temperature sensor for measuring and reporting ambient room temperature;
a processor configured to mathematically calculate rate of change of measured temperature of said first temperature sensor relative to rate of change of measured temperature of said second temperature sensor;
a transmitter for transmitting measurements to at least said processor;
a timing device measuring time passed; and
wherein leak is determined based upon detection of a rate of change of temperature of said pipe being less than a threshold compared to a rate of change of said ambient room temperature, and consequently triggering an alarm.

2-5. (canceled)

6. The leak detection device of claim 1, wherein said alarm is triggered only when change in temperature reported by said first sensor persists over a minimum threshold period of time.

7. The leak detection device of claim 6, wherein a lack of change in temperature reported by said first sensor over said minimum threshold period of time signals deactivating said alarm.

8. The leak detection device of claim 6, wherein a lack of change in temperature reported by said first sensor over said minimum threshold period of time activates said alarm when said temperature of said pipe is at least 10 degrees Celsius different from the temperature reported by said second sensor.

9-15. (canceled)

16. The leak detection device of claim 1, wherein said alarm is remote from said device.

17. The leak detection device of claim 1, wherein said mathematical calculation includes use of a line equation determined from determining temperature over time and taking a derivative thereof.

18. The leak detection device of claim 1, wherein said alarm is triggered when the temperature as measured by the first sensor remains at a minimum difference from the temperature measured by the second sensor for a defined time period.

19. The leak detection device of claim 1, wherein when said calculation of the rate of change during a period of low or no usage is less than according to Newton's law of cooling, said alarm is triggered.

20. A system for determining at least one pipe leak across one or more pipes comprising:
a plurality of wraps, each said wrap affixed to the exterior of a pipe and comprising a first temperature sensor positioned in contact with or near a given pipe for measuring temperature of said pipe, a second temperature sensor positioned for measuring ambient room temperature surrounding said given pipe, and a transmitter for capturing sensor data and for wirelessly delivering said data to a remote processor;
a remote processor configured to mathematically calculate rate of change of measured temperature of said first temperature sensor in said given wrap relative to rate of change of measured temperature of said second temperature sensor in said given wrap; and
a timing device;
wherein leak for a pipe with an affixed given wrap is determined by said remote processor when determined rate of change of temperature of said pipe is less than a threshold compared to rate of change of said ambient room temperature.

21. The system of claim 20, wherein an alarm is triggered when said change in temperature of said first temperature sensor persists over a pre-defined minimum threshold period of time.

22. The system of claim 21, wherein lack of change in temperature of said first sensor over a minimum threshold time period deactivates said alarm.

23. The system of claim 21, wherein a lack of change in temperature of said first sensor over a minimum threshold period activates said alarm when said first sensor measures at least a 10 degrees Celsius difference from said second sensor.

24. The system of claim 21, wherein said alarm is remote from said wrap.

25. A method for a processor to remotely detect a leaking pipe across a plurality of water-carrying pipes, comprising the steps of:
affixing at least one sleeve to each of a plurality of pipes, each sleeve comprising a first temperature sensor positioned for measuring temperature of said pipe and a second temperature sensor positioned for measuring ambient room temperature;
collecting data from said sensors relative to time;
wirelessly transmitting said collected data to a remote processor;
said processor determining a leaking pipe based upon said processor being configured to mathematically calculate rate of change of measured temperature of said first temperature sensor in a particular sleeve relative to rate of change of measured temperature of said second temperature sensor in said particular sleeve and upon detection of a rate of change of temperature of said first sensor being less than a threshold compared to a rate of change of said change of temperature of said second sensor determining a leak, and
triggering an alarm.

26. The method of claim 25, wherein said alarm is triggered only when change in temperature reported by said first temperature sensor persists over a pre-defined minimum threshold period of time.

27. The method of claim 26, wherein a lack of said change in temperature of said first sensor over said minimum threshold period of time signals deactivating said alarm.

28. The method of claim 26, wherein a lack of said change in temperature of said pipe over said minimum threshold period of time signals activates said alarm when said temperature of said pipe is at least 10 degrees Celsius different from said ambient room temperature.

29. The method of claim 25, wherein said alarm is remote from said sleeve.

30. The method of claim 25, wherein said mathematical calculation includes use of a line equation determined from taking a derivative of temperature over time.

31. The method of claim 25, wherein said alarm is triggered when the temperature as measured by the first sensor remains at a minimum difference from the temperature measured by the second sensor for a defined time period.
